(19) United States
(12) Patent Application Publication
(10) Pub. No.: US 2026/0273540 A1
(43) Pub. Date: Sep. 17, 2026

(54) A MILL FOR AN AIR-FORMED CELLULOSE BLANK PRODUCT AND METHOD FOR USING THE SAME

(71) Applicant: PulPac AB, Västra Frölunda (SE)

(72) Inventor: Ove LARSSON, Västra Frölunda (SE)

(21) Appl. No.: 19/480,156

(22) PCT Filed: Apr. 18, 2024
(86) PCT No.: PCT/EP2024/060596

§ 371 Date: Oct. 30, 2025

(30) Foreign Application Priority Data
May 2, 2023 (SE) 2350525-8

(51) Int. Cl. B02C 18/22; B02C 18/14; D21B 1/06

(52) U.S. Cl. CPC B02C 18/2283; B02C 18/14; B02C 18/2216; D21B 1/066; B02C 2018/2208

(57) ABSTRACT

A mill for separating fibres including: a mill head for separating fibres from a compressed pulp sheet, an enclosure, an inlet opening, an outlet opening, an infeed region arranged to feed a first pulp sheet or a second pulp sheet to the mill head, wherein the infeed region includes a first infeed path, first infeed path is arranged to be in an active state when a second infeed path is in an idle state, where a first pulp sheet is arranged to be fed to the mill head by the active first infeed path, and where the second pulp sheet is arranged to rest in the idle second infeed path, wherein the infeed region is arranged to switch state of the infeed paths when a signal is issued indicating the end of a first pulp sheet in the active first infeed path.

### TECHNICAL FIELD

The present disclosure relates to a mill to be used when forming an air-formed cellulose blank structure for forming non-flat cellulose products from the air-formed cellulose blank structure. The disclosure further relates to a method for forming an air-formed cellulose blank structure using the mill.

The mill according to the disclosure will be described primarily in relation to an example cellulose product forming unit having an integrated fibre separating module comprising the mill, a cellulose blank air-forming module, etc., but the mill and associated method for using the same is not limited to this specific implementation and may alternatively be implemented and used in many other types of cellulose products manufacturing systems.

### BACKGROUND

Cellulose fibres are often used as raw material for producing or manufacturing products. Products formed of cellulose fibres can be used in many different situations where there is a need for having sustainable products. A wide range of products can be produced from cellulose fibres and a few examples are disposable plates and cups, cutlery, lids, bottle caps, coffee pods, and packaging materials.

Forming moulds are commonly used when manufacturing cellulose products from cellulose fibre raw materials, and traditionally the cellulose products are wet-formed. A material commonly used for wet-forming cellulose fibre products is wet moulded pulp. Wet moulded pulp has the advantage of being considered as a sustainable packaging material, since it is produced from biomaterials and can be recycled after use. Consequently, wet moulded pulp has been quickly increasing in popularity for different applications. Wet moulded pulp articles are generally formed by immersing a suction forming mould into a liquid or semi liquid pulp suspension or slurry comprising cellulose fibres, and when suction is applied, a body of pulp is formed with the shape of the desired product by fibre deposition onto the forming mould. With all wet-forming techniques, there is a need for drying of the wet moulded product, where the drying is a very time and energy consuming part of the production. The demands on aesthetical, chemical and mechanical properties of cellulose products are increasing, and due to the properties of wet-formed cellulose products, the mechanical strength, flexibility, freedom in material thickness, and chemical properties are limited. It is also difficult in wet-forming processes to control the mechanical properties of the products with high precision.

One development in the field of producing cellulose products is the forming of cellulose fibres in a dry-forming process, without using wet-forming. Instead of forming the cellulose products from a liquid or semi liquid pulp suspension or slurry, an air-formed cellulose blank structure is used. The air-formed cellulose blank structure is inserted into forming moulds and during the forming of the cellulose products the cellulose blank structure is subjected to a high forming pressure and a high forming temperature in the forming moulds.

Manufacturing of cellulose products by compression moulding of an air-formed cellulose blank structure may be performed in production lines or product forming units. The manufacturing equipment commonly includes a pressing module comprising the forming moulds. Other modules and components are arranged in connection to the pressing module, such as for example feeding modules, buffering modules, and blank dry forming modules. The pressing module is normally a high capacity pressing module, such as large hydraulic or servo powered pressing machines, which may be used for forming other materials such as steel plates, since these modules are available as stand-alone off-the shelf machinery.

The air-formed cellulose blank structure is formed from e.g. a pulp roll that is defibrated by the mill, where the fibres are moved by air to form the air-formed cellulose blank structure. It is desirable to produce a constant, uniform fibre flow such that the density of the air-formed cellulose blank structure is within predefined limits. One problem with using pulp rolls as starting material is that a pulp roll must be replaced with a new one when the first pulp roll is finished. This exchange of pulp rolls will cause a disruption in the fibre flow, which in turn will affect the density of the air-formed cellulose blank structure.

Further, such a replacement will take some time and will involve manual labour, since the last part of the finished pulp roll must be removed manually before the new pulp roll can be inserted into the mill.

There is thus a need for an improved mill having an improved feeding system of pulp rolls, as well as a method for forming an air-formed cellulose blank structure by using such a mill. There is also a need for a mill that is able to receive an unused air-formed cellulose blank structure from the cellulose product pressing module.

### SUMMARY

An object of the present disclosure is to provide a mill for separating fibres from a compressed pulp sheet cellulose for forming non-flat cellulose products from an air-formed cellulose blank structure, as well as an associated method for forming non-flat cellulose products from an air-formed cellulose using such a mill, where the previously mentioned problems are avoided. This object is at least partly achieved by the features of the independent claims.

According to a first aspect of the present disclosure, there is provided a mill for separating fibres from a compressed pulp sheet for forming non-flat cellulose products from an air-formed cellulose blank structure, where the mill comprises a mill head for separating fibres from a compressed pulp sheet, an enclosure enclosing the mill head, an inlet opening ( ) for air, an outlet opening for an air-fibre mixture, an infeed region arranged to feed a first pulp sheet or a second pulp sheet to the mill head, wherein the infeed region comprises a first infeed path and a second infeed path, where one infeed path is in an active state when the other infeed path is in an idle state, where a pulp sheet is fed to the mill head by an active infeed path, and a pulp sheet is resting in an idle infeed path, wherein the infeed region is arranged to switch state of the infeed paths when a signal is issued indicating the end of a pulp sheet in the active infeed path.

According to a second aspect of the present disclosure, there is provided a method for forming non-flat cellulose products from an air-formed cellulose blank structure using a mill. The method comprises providing a cellulose product toggle pressing module having a toggle press and a forming mould. The toggle press includes a pressing member movably arranged in a pressing direction, a toggle-mechanism connected to the pressing member, a pressing actuator arrangement connected to the toggle-mechanism, and an electronic control system operatively connected to the pressing actuator arrangement, and the forming mould includes a moveable first mould part attached to the pressing member and a second mould part. The method further comprises installing the toggle press with the pressing direction of the pressing member arranged primarily in a horizontal direction, specifically with the pressing direction of the pressing member arranged within 20 degrees from the horizontal direction, and more specifically with the pressing direction in parallel with the horizontal direction. The method further comprises feeding an air-formed cellulose blank structure into a pressing area defined by the first and second, spaced apart, mould parts, and controlling operation of the pressing actuator arrangement by means of the electronic control system for driving the pressing member using the toggle-mechanism in the pressing direction and forming the non-flat cellulose product from the air-formed cellulose blank structure by pressing the first mould part against the second mould part.

By providing the mill with an infeed region having two separate infeed paths, a quick and secure replacement of a finished pulp sheet to a new pulp sheet can be made. A new pulp sheet is positioned in an idle infeed path, and when the pulp sheet in the active infeed path is finished, a quick switch of the state of the infeed paths is performed. The infeed region uses the same infeed brake bar for both infeed paths, which means that the fibre flow from the mill head will be the same regardless of the used infeed path, which in turn means that the air-formed cellulose blank structure will be identical when both infeed paths are used. This will ensure that the density of the air-formed cellulose blank structure will not change depending on the used infeed path.

Further advantages are achieved by implementing one or several of the features of the dependent claims. For example, in some example embodiments, which may be combined with any one or more of the above-described embodiments, the infeed region of the mill comprises a driven feeder roller, where the feeder roller is arranged to rotate in a first direction when feeding a pulp sheet to the mill head in the first infeed path, and to rotate in a second direction when feeding a pulp sheet to the mill head in the second infeed path. By using a single feeder roller for both infeed paths, a more compact and cost-effective infeed solution is obtained.

In some example embodiments, the infeed region of the mill comprises a first displaceable passive roller arranged in the first infeed path and a second displaceable passive roller arranged in the second infeed path, where the first displaceable passive roller is arranged to bear on the pulp sheet when the first pulp path is in an active state such that the pulp sheet is securely held between the driven feeder roller and the first passive roller, and where the second displaceable passive roller is arranged to be retracted when the second pulp path is in an idle state. The use of displaceable passive rollers allows the use of a single feeder roller for both infeed paths, which in turn allows for a compact infeed solution.

In some example embodiments, the first infeed path comprises first holder means arranged to hold a pulp sheet in a fixed position when the first infeed path is in an idle state, and wherein the second infeed path comprises second holder means arranged to hold a pulp sheet in a fixed position when the second infeed path is in an idle state. The use of holder means to hold a pulp sheet in an idle infeed path allows for a quick and secure switch from an idle state to an active state of an infeed path.

In some example embodiments, the first infeed path comprises a first detector arranged to detect the end of a pulp sheet in the first infeed path, and the second infeed path comprises a second detector arranged to detect the end of a pulp sheet in the second infeed path. A sensor is used to detect the end of a pulp sheet, such that a new pulp sheet can be fed tot eh mill head.

In some example embodiments, infeed region comprises a braker bar having an upper part and a lower part arranged to hold and guide the pulp sheet when the pulp sheet is fed to the mill head, where the braker bar is provided with radiuses at the braker bar inlet. The use of radiuses at the braker bar inlet facilitates the feeding of a pulp sheet into the braker bar, especially since the inlet angle of each pulp sheet will be slightly offset with regards to the brake bar.

In some example embodiments, the mill comprises an electronic control unit arranged to control the rotational direction of the feeder roller, the position of the first passive roller and the position of the second passive roller, in dependency of a signal issued by the first detector and/or the second detector. This enables a flexible and adaptable control of the state switch of an infeed path.

In some example embodiments, the mill further comprises a return infeed path arranged to receive unused pulp sheet from a pressing station, where the return infeed path comprises a first infeed belt and a second infeed belt. The use of infeed belts allows to feed unused pulp sheet to the mill head, where the density of the unused pulp sheet may vary.

In some example embodiments, the first infeed belt of the return infeed path is provided with a first roller and a second roller, where the position of the first roller is fixed and the position of the second roller is adjustable in order to control the pressure from the first infeed belt, and where the second infeed belt of the return infeed path is provided with a first roller and a second roller, where the position of the first roller is adjustable in order to control the pressure from the second belt and where the position of the second roller is fixed. In this way, a secure return of unused pulp sheet can be ensured, regardless of the density of the unused pulp sheet.

In some example embodiments, the first infeed belt is longer than the second infeed belt. This will simplify the insertion of an unused pulp sheet into the return path.

In some example embodiments, the adjustment of the second roller of the first infeed belt and the adjustment of the first roller of the second infeed belt is performed by linear actuators. This allows for an easy adjustment of the feeding pressure in the return infeed path.

In some example embodiments, the return infeed path comprises a braker bar having an upper part and a lower part arranged to hold and guide the return pulp sheet when the return pulp sheet is fed to the mill head, where the braker bar is provided with radiuses at the braker bar inlet. The use of radiuses at the braker bar inlet facilitates the feeding of an unused pulp sheet into the braker bar.

Further features and advantages of the invention will become apparent when studying the appended claims and the following description. The skilled person in the art realizes that different features of the present disclosure may be combined to create embodiments other than those explicitly described hereinabove and below, without departing from the scope of the present disclosure.

### BRIEF DESCRIPTION OF DRAWINGS

The mill and associated method for forming non-flat cellulose according to the disclosure will be described in detail in the following, with reference to the attached drawings, in which

FIG. 1 show schematically in a side view a product forming unit according to the disclosure,

FIG. 2 shows schematically in a side view a mill according to the disclosure,

FIG. 3 show schematically a first pulp sheet fed by a first active infeed path according to the disclosure,

FIG. 4 shows schematically the end of a first pulp sheet in the first active infeed path according to the disclosure,

FIG. 5 show schematically an example of a state switch of the infeed paths according to the disclosure,

FIG. 6 show schematically the feeding of a second pulp sheet in a second active infeed path according to the disclosure,

FIG. 7 shows schematically the insertion of a first pulp sheet in an idle first infeed path according to the disclosure.

### DESCRIPTION OF EXAMPLE EMBODIMENTS

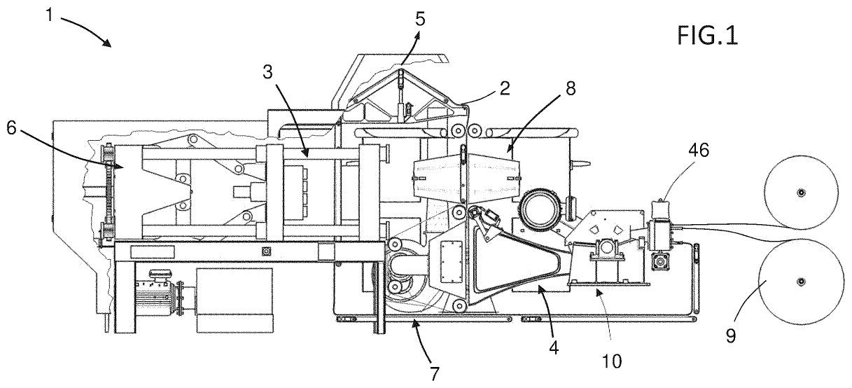

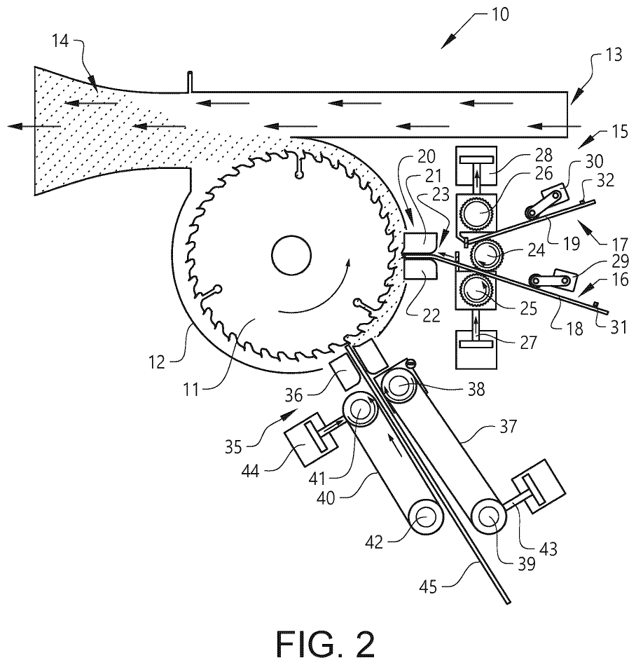

Various aspects of the disclosure will hereinafter be described in conjunction with the appended drawings to illustrate and not to limit the disclosure, wherein like designations denote like elements, and variations of the described aspects are not restricted to the specifically shown embodiments, but are applicable on other variations of the disclosure. FIG. 1 shows an example of a product forming unit and FIGS. 2 to 7 shows examples of a mill to be used in a product forming unit.

FIG. 1 schematically show a product forming unit 1 for manufacturing non-flat cellulose products from an air-formed cellulose blank structure 2. The product forming unit 1 comprises a blank dry-forming module 4 provided with a mill 10, a buffering module 5, a pressing module 6, a blank recycling module 7 and a barrier application module 8. The cellulose products are manufactured from the cellulose blank structure 2 in the product forming unit 1. The cellulose blank structure 2 is provided from a suitable source and fed to the buffering module 5 and the pressing module 6. The forming of the cellulose products 1 is accomplished in the pressing module 6. With non-flat products is meant products that have an extension in three dimensions, which is different from flat products like blanks or sheets.

With an air-formed cellulose blank structure 2 according to the disclosure is meant an essentially air-formed fibrous web structure produced from cellulose fibres. The cellulose fibres may originate from a suitable cellulose raw material, in the shown example from a compressed pulp sheet. With air-forming of the cellulose blank structure 2 is meant the formation of a cellulose blank structure in a dry-forming process in which the cellulose fibres are air-formed to produce the cellulose blank structure 2. When forming the cellulose blank structure 2 in the air-forming process, the cellulose fibres are carried and formed to the fibre blank structure 2 by air as carrying medium. This is different from a normal papermaking process or a traditional wet-forming process, where water is used as carrying medium for the cellulose fibres when forming the paper or fibre structure. In the air-forming process, small amounts of water or other substances may if desired be added to the cellulose fibres in order to change the properties of the cellulose product, but air is still used as carrying medium in the forming process. The cellulose blank structure 2 may, if suitable have a dryness that is mainly corresponding to the ambient humidity in the atmosphere surrounding the air-formed cellulose blank structure 2. As an alternative, the dryness of the cellulose blank structure 2 can be controlled in order to have a suitable dryness level when forming the cellulose products.

The blank dry-forming module 4 is integrated in the product forming unit 1 as showed in FIG. 1. The blank dry-forming module is in the shown example provided with a horizontal blowing direction of the air-fibre mixture from the mill 10 to a forming wire, on which the air-formed cellulose blank structure is formed. Since the length of the fibre carrying distance by air, inside a forming chamber of the blank dry-forming module 4, needs to be enough to equalize turbulence and/or create a uniform flow of cellulose fibres, this embodiment with the horizontal blowing direction reduces the height of the product forming unit and enables access for maintenance to the mill from plant floor without additional elevated flooring or platforms. In the example shown in FIG. 1, the air-fibre mixture outlet is arranged at the bottom of the mill.

In particular, the cellulose raw material 9 is provided from a suitable source, in the shown example from a compressed pulp sheet provided on a pulp roll, and the cellulose raw material is fed to the blank dry-forming module 4. The cellulose blank structure 2 is dry-formed from the cellulose raw material in the blank dry-forming module 4, and thereafter the cellulose blank structure 2 is fed from the blank dry-forming module 4 to the buffering module 5. The blank dry-forming module 4 comprises a mill 10, a forming chamber and a forming wire arranged in connection to the forming chamber. Fibres from the cellulose raw material is separated from the cellulose raw material in the mill 10 and the separated fibres are distributed into the forming chamber onto the forming wire for forming the cellulose blank structure 2. The mill 10 is configured for separating cellulose fibres from the cellulose raw material, and the forming chamber is configured for distributing the separated fibres onto a forming section of the forming wire for forming the cellulose blank structure 2. The forming section is arranged in connection to a forming chamber opening of the forming chamber. In the shown example, the forming section is extending in a vertical direction. The cellulose blank structure 2 is formed onto the forming section and transported from the forming section upwards towards the buffering module 5. The upwards blank forming direction is used for a compact configuration and layout of the product forming unit 1, allowing an efficient positioning of the different modules of the product forming unit 1 in relation to each other. After forming of the cellulose blank structure 2 onto the forming section, the formed cellulose blank structure 2 is transported from the forming section in the upwards blank forming direction towards the buffering module 5.

The mill 10 is separating the fibres from the cellulose raw material 9 and is distributing the separated fibres into the forming chamber. In the shown example, the cellulose raw material consists of a compressed pulp sheet or a thicker paper in the form of a pulp roll, that are fed into the mill 10. The mill 10 may be of any conventional type, such as for example a hammer mill, a saw-tooth mill, or other type of pulp de-fiberizing machine. In the shown example, a saw-tooth mill is used. The pulp sheet is fed into the mill 10 through an infeed region 15, and the separated fibres are distributed as an air-fibre mixture to the forming chamber through an outlet opening 14 of the mill 10 arranged in connection to the forming chamber. The mill 10 further comprises a mill head 11 having a saw-tooth shape, an enclosure 12 enclosing the mill head and an inlet opening 13 for air.

The forming wire may be of any suitable conventional type, and may be formed as an endless belt structure, as illustrated in FIG. 1. A vacuum box may be arranged in connection to the forming wire and the forming chamber for controlling the flow of air in the forming chamber, and for distributing the separated fibres onto the forming wire.

The air-formed cellulose blank structure 2 may be formed of cellulose fibres in a conventional air-forming process or in a blank dry-forming module 4 as illustrated in FIG. 1 and may be configured in different ways. For example, the cellulose blank structure 2 may have a composition where the fibres are of the same origin or alternatively contain a mix of two or more types of cellulose fibres, depending on the desired properties of the cellulose products. The cellulose fibres used in the cellulose blank structure 2 are during the forming process of the cellulose products strongly bonded to each other with hydrogen bonds. The cellulose fibres may be mixed with other substances or compounds to a certain amount. With cellulose fibres is meant any type of cellulose fibres, such as natural cellulose fibres or manufactured cellulose fibres. The cellulose blank structure 2 may specifically comprise at least 95% cellulose fibres, or more specifically at least 99% cellulose fibres.

The air-formed cellulose blank structure 2 may have a single-layer or a multi-layer configuration. A cellulose blank structure 2 having a single-layer configuration is referring to a structure that is formed of one layer containing cellulose fibres. A cellulose blank structure 2 having a multi-layer configuration is referring to a structure that is formed of two or more layers comprising cellulose fibres, where the layers may have the same or different compositions or configurations.

The cellulose blank structure 2 may comprise a reinforcement layer comprising cellulose fibres, where the reinforcement layer may be arranged as a carrying layer for one or more other layers of the cellulose blank structure 2. The reinforcement layer may have a higher tensile strength than other layers of the cellulose blank structure 2. This is useful when one or more air-formed layers of the cellulose blank structure 2 have compositions with low tensile strength in order to avoid that the cellulose blank structure 2 will break during the forming of the cellulose products 1. The reinforcement layer with a higher tensile strength acts in this way as a supporting structure for other layers of the cellulose blank structure 2. The reinforcement layer may be of a different composition than the rest of the cellulose blank structure, such as for example a tissue layer containing cellulose fibres, an airlaid structure comprising cellulose fibres, or other suitable layer structures. It is thus not necessary that the reinforcement layer is air-formed. The cellulose blank structure 2 may comprise more than one reinforcement layer if suitable.

The one or more air-formed layers of the cellulose blank structure 2 are fluffy and airy structures, where the cellulose fibres forming the structures are arranged relatively loosely in relation to each other. The fluffy cellulose blank structures 2 are used for an efficient forming of the cellulose products, allowing the cellulose fibres to form the cellulose products in an efficient way during the forming process.

The product forming unit 1 may further comprise a barrier application module 8 arranged downstream the buffering module 5, as shown in FIG. 1. The barrier application module 8 is configured for applying a barrier composition onto the cellulose blank structure 2 before forming the cellulose products in one or more forming moulds 3.

The product forming unit 1 shown in FIG. 1 comprises the buffering module 5 and the pressing module 6. The product forming unit 1 is adapted for feeding the cellulose blank structure 2 to the buffering module 5, buffering the cellulose blank structure 2 in the buffering module 5, and feeding the cellulose blank structure 2 from the buffering module 5 to the pressing module 6. The product forming unit 1 is further adapted for forming non-flat cellulose products from the cellulose blank structure 2 in the one or more forming moulds 3 by heating the cellulose blank structure 2 to a forming temperature and pressing the cellulose blank structure 2 with the forming pressure. The one or more forming moulds 3 are configured for forming the non-flat cellulose products from the cellulose blank structure 2 by heating the cellulose blank structure 2 to the forming temperature in the range of 100-300° C., and pressing the cellulose blank structure 2 with a forming pressure in the range of 1-100 MPa, preferably 4-20 MPa. When forming the cellulose products, strong hydrogen bonds are formed between the cellulose fibres in the cellulose blank structure 2 arranged between the first mould part and the second mould part. The temperature and pressure levels are for example measured in the cellulose blank structure 2 during the forming process with suitable sensors arranged in or in connection to the cellulose fibres in the cellulose blank structure 2.

With reference to FIG. 1, the blank dry-forming module 4 typically forms the start of the feeding route and the pressing module 6 typically forms the end of the feeding route, when not taking the blank recycling module 7 into account. Other modules, such as the buffering module 5 and barrier application module 8 are located at any suitable positions between the dry-forming module 4 and the pressing module 6, i.e. downstream of the dry-forming module 4 and upstream of the pressing module 6, and not necessarily at the example positions of the embodiment of FIG. 1. The primarily downwards routing of the cellulose blank structure while passing the pressing module 6 is beneficial in terms of simplified feeding of the cellulose blank structure 2, as well as simplified cellulose products plundering after completed forming process, i.e. upon leaving the pressing module 6.

The pressing module 6 comprises one or more forming moulds 3, and each forming mould 3 comprises a first mould part and a second mould part. Corresponding first and second mould parts are cooperating with each other during the forming of the non-flat cellulose products in the pressing module 6. Each first mould part and corresponding second mould part are movably arranged in relation to each other, and the first mould part and the second mould part are configured for moving in relation to each other in a pressing direction of the pressing module 6. The pressing module 6 may be of a single-cavity configuration or alternatively of a multi-cavity configuration.

FIG. 2 shows a schematic side view of the mill 10. The mill comprises a mill head 11. In the shown example, the mill head is of the saw tooth-type, but other types of mill heads are also possible, such as a hammer mill head. The mill head is enclosed by an enclosure 12 which encloses the mill head more or less completely, such that defibrated fibres do not escape the enclosure in undesirable places. The mil further comprises an inlet opening 13 arranged as an air inlet to the mill, and an outlet opening 14 through which an air-fibre mixture leaves the mill to form an air-formed cellulose blank structure on the forming wire of the blank dry-forming module 4. The mill 10 is further provided with an infeed region, at which the cellulose raw material 9 in the form of a compressed pulp sheet is fed to the mill head.

The infeed region comprises a first infeed path 16 and a second infeed path 17, where the first infeed path 16 is arranged to feed a first pulp sheet to the mill head, and where the second infeed path is arranged to feed a second pulp sheet to the mill head. In the infeed region, one infeed path is in an active state when the other infeed path is in an idle state, where a pulp sheet is fed to the mill head by an active infeed path and the other pulp sheet is resting in an idle infeed path. The infeed region is arranged to switch state of the infeed paths when a signal is issued indicating the end of a pulp sheet in the active infeed path.

In FIG. 2, the first infeed path is in an active state, where the first pulp sheet 18 is fed to the mill head through a braker bar 20. The pulp sheet is forwarded by a feeder roller 24 that is arranged between the first infeed path and the second infeed path. The feeder roller is arranged to feed either the first pulp sheet or the second pulp sheet, depending on which infeed path that is active. In the shown example, the feeder roller drives the first pulp sheet by rotating in a clockwise direction. A first passive roller 25 is pressed against the first pulp sheet and the feeder roller with a predefined pressure such that the first pulp sheet is held and driven in a secure way, ensuring that the pulp sheet does not slip and that the feeding of the pulp sheet is consistent. The first passive roller is actuated by a first actuator 27. The first actuator 27 preferably comprises one actuator at each end of the passive roller. The first actuator may e.g. be an air operated actuator having two positions, one extended position and one retracted position, or may be a linear electric actuator having either two or more positions. The rotational direction of the feeder roller and the position of the first actuator is preferably controlled by an electronic control unit (ECU) 46.

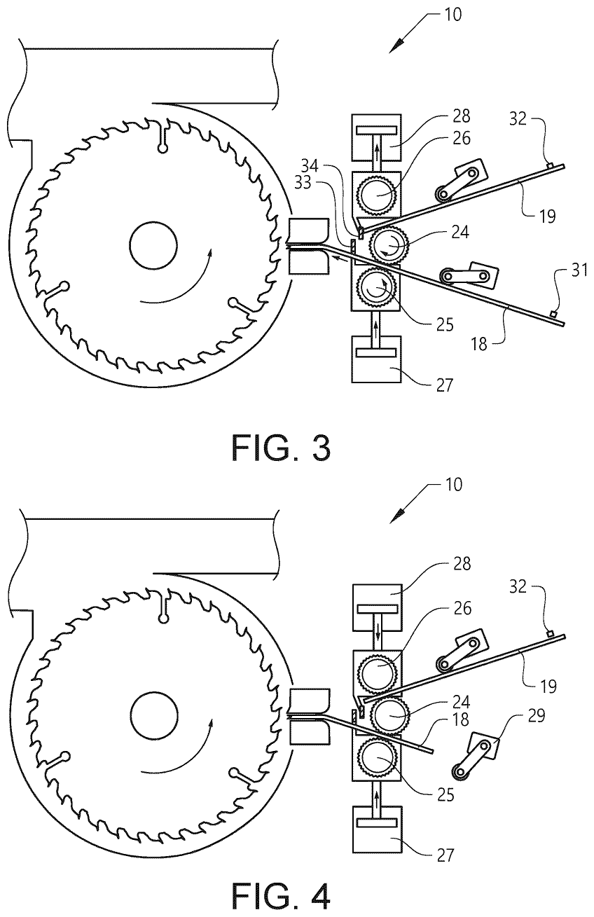

The feeder roller 24 forwards the first pulp sheet with a predefined speed. The feeding of the first pulp sheet is either constant or intermittent, depending on the product forming unit 1. If the product forming unit is provided with a buffering module 5, the feeding of a pulp sheet may be constant, if the product forming unit is not provided with a buffering module, the feeding of a pulp sheet may be intermittent and adapted to the speed of the pressing module 6. The rotational speed of the feeder roller is set in dependency of the requirements of the air-formed cellulose blank structure, e.g. in independency of the desired density of the air-formed cellulose blank structure. FIG. 3 shows the feeding of the first pulp sheet to the mill head. The second pulp sheet is positioned in an idle position, where the start of the second pulp sheet bears on the second stop member 34, such that a well-defined start position is obtained. This will simplify the feeding of the second pulp sheet into the braker bar inlet.

The first pulp sheet is forwarded to the mill head by the feeder roller. A first detector 29 is arranged in the first infeed path and is arranged to detect the presence of a pulp sheet in the first infeed path. The first detector may e.g. be an optical detector or a mechanical microswitch bearing on the pulp sheet. The first detector detects the end of the first pulp sheet and sends a signal to the ECU indicating the end of the first pulp sheet. The position of the detector will also determine the length of the remaining pulp sheet. The detection of the end of the first pulp sheet is shown in FIG. 4. The second infeed path 17 comprises a similar second detector 30.

The remaining length of the pulp sheet is used to optimize the usage of the pulp sheet. The forming mould will a specific length of air-formed cellulose blank structure for each pressing cycle. This corresponds in turn to a specific length of pulp sheet that is required to form the length of the air-formed cellulose blank structure to be used in a pressing cycle. When the first detector has detected the end of the first pulp sheet, the ECU can determine how much of the remaining pulp sheet that can be forwarded to the mill head with the pulp sheet being held between the feeder roller and the first passive roller. It is important that the pulp sheet is always in driving contact with the feeder roller.

When as much as possible of the remaining pulp sheet has been used, the rotational direction of the feeder roller is reversed, and is in this case rotated in a counter-clockwise direction such that the pulp sheet is moved away from the mill head and the braker bar. This movement is stopped when the start of the pulp sheet has passed a first stop member 33 and is close to the feeder roller. The first stop member 33 comprises in the shown example two stop flanges arranged at each side of the first infeed path. The first pulp sheet is now out of the way at the braker bar inlet, such that a new pulp sheet can be fed to the mill head, as shown in FIG. 6. When the start of the first pulp sheet has passed the position of the first stop member and is at the feeder roller, the first passive roller is retracted from the pulp sheet such that the pulp sheet is not driven by the feeder roller. At the same time, first holding means 31 will clamp and hold the remaining first pulp sheet in a fixed position. The first infeed path is now in an idle state. The feeder roller may at this point stop rotating or may continue to rotate in the counter-clockwise direction.

At the same time, the state of the second infeed path will switch from an idle state to an active state. Up till now, the second infeed path has been in an idle state, in which the second pulp sheet has been positioned in an idle position in which the start of the second pulp sheet bears on a second stop member 34, defining a start position of the second pulp sheet. The second pulp sheet is in this position held in a fixed position by second holding means 32 that will clamp and hold the second pulp sheet. When the first pulp sheet has been retracted from the mill head and is positioned in an idle position, the second infeed path is set to an active state. The second passive roller is pressed against the second pulp sheet and the feeder roller by actuating the second actuator, and the feeder roller is controlled to rotate in the counter-clockwise direction. At the same time, the second holding means is released such that the second pulp sheet can move freely in the second infeed path. When the second passive roller is activated, the second stop member is moved away from the second infeed path such that the second pulp sheet can be forwarded towards the braker bar and the mill head. The second pulp sheet will enter the braker bar at the braker bar inlet, where the radiuses at the braker bar inlet ensures that the start of the second pulp sheet can enter the braker bar inlet securely. The second infeed path is now in an active state, feeding the second pulp sheet to the mill head such that the air-formed cellulose blank structure can be formed as desired.

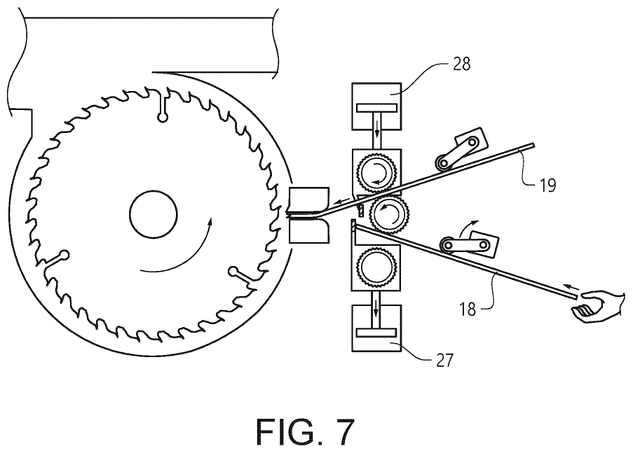

The remaining first pulp sheet in the first infeed path, that is now in an idle state, can now be removed from the first infeed path and a new pulp sheet can be loaded into the first infeed path. To remove the remaining pulp sheet, the first holding means is released such that the first pulp sheet is free. The first pulp sheet is removed manually. A new first pulp sheet is inserted into the first infeed path and is forwarded manually until it bears on the first stop member 33 arranged in the first infeed path, as shown in FIG. 7. The first stop member will ensure that the first pulp sheet is in a correct position when the second pulp sheet ends and the infeed paths will switch state. When the first pulp sheet is in position, the first holding means 31 is activated such that the first pulp sheet is held in a fixed position. The first detector will indicate that a pulp sheet is positioned in the first infeed path and that the first infeed path is ready for the next state switch of the infeed paths. A second detector 30 will monitor the second pulp sheet and will indicate when the second pulp sheet ends.

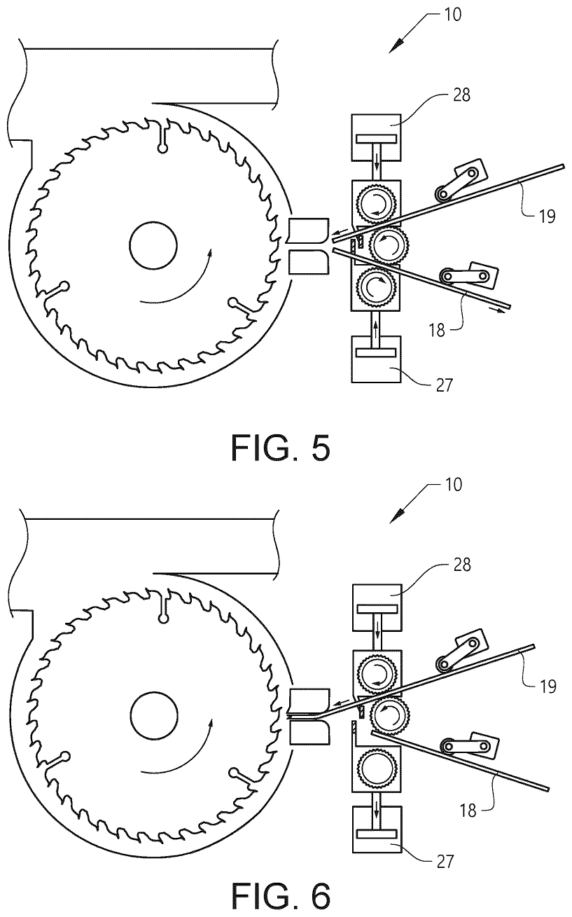

In one example shown in FIG. 5, the removal of the remaining first pulp sheet in the first infeed path and the feeding of the second pulp sheet to the mill head is done simultaneously. In this example, the feeder roller changes the rotational direction when it is determined that as much as possible of the remaining pulp sheet has been used. The remaining first pulp sheet will now be retracted from the braker bar. When the feeder roller changes the rotational direction, the second passive roller is extended such that it presses the second pulp sheet towards the feeder roller. At the same time, the second holding means is deactivated, such that the second pulp sheet is forwarded towards the inlet of the braker bar by the feeder roller. When the first pulp sheet has passed the first stop member, the first passive roller is retracted and the first holding means is activated such that the remaining first pulp sheet is held in a fixed position. The first pulp sheet can then be removed manually.

The braker bar 20 is arranged to hold and guide the pulp sheet to the mill head. The braker bar comprises an upper part 21 and a lower part 22, where the upper part and the lower part are arranged apart with a distance that is slightly larger than the thickness of the pulp sheet. This allows the pulp sheet to be held securely in position when the mill head defibrates the pulp sheet. This in turn ensures that the fibres are defibrated in the same uniform way. The edges of the braker bar inlet 23 are provided with a radius such that the pulp sheet can be fed to the braker bar with an offset angle without being caught on the edges.

Further, the product forming unit 1 comprises a blank recycling module 7 for recycling cellulose fibres. The blank recycling module 7 is configured for feeding residual parts of the cellulose blank structure 2 after forming of the cellulose products, from the pressing module 6 back to the blank dry-forming module 4. The blank recycling module 7 is arranged for transporting residual cellulose blank fibre material from the pressing module 6 to the mill 10. After forming of the cellulose products in the forming moulds 3, there may be residual parts of the cellulose blank structure containing cellulose blank fibre material. With the blank recycling module 7, the residual or remaining cellulose fibres can be recycled and re-used for forming a new cellulose blank structure 2 together with fibres from the cellulose raw material. In FIG. 1, an example embodiment of a blank recycling module 7 is schematically illustrated. The blank recycling module 7 comprises a feeding structure, such as feeding belts, a conveyer structure, or other suitable means for transporting the residual parts from the forming moulds 3 to the mill 10. The mill 10 is provided with a return infeed path 35 for the residual material, where the residual parts of the cellulose blank structure 2 are fed into the mill 10.

The return infeed path 35 arranged to feed unused air-formed cellulose blank structure from the pressing module to the mill head. The unused air-formed cellulose blank structure is the part of the air-formed cellulose blank structure that has not been pressed to products in the pressing module. The air-formed cellulose blank structure is preferably compressed either in the pressing module or by a roller after the pressing module such that it resembles a pulp sheet, forming a return pulp sheet 45. In this way, the unused air-formed cellulose blank structure can be defibrated in the same mill head. The return infeed path is arranged upstream of the infeed region 15. The infeed region is arranged close to the outlet opening 14, and the return infeed path is arranged close to the infeed region. It is of advantage to position the infeed region 15 as close to the outlet opening 14 as possible, and to position the return infeed path 35 as close to the infeed region 15 as possible. In the shown example, the infeed region is positioned in a horizontal plane arranged through the centre axis of the mill head, and the return infeed path is arranged below the infeed region.

The return infeed path comprises a return braker bar 36 which is more or less similar to the braker bar 20. The edges of the braker bar inlet are also provided with radiuses in order to simplify the insertion of the unused return pulp sheet into the braker bar. The return infeed path 35 comprises a first infeed belt 37 and a second infeed belt 40. The first infeed belt 37 is provided with a first roller 38 and a second roller 39, where the position of the first roller is fixed and the position of the second roller is adjustable in order to control the pressure from the first infeed belt 37. The second infeed belt 40 is provided with a first roller 41 and a second roller 42, where the position of the first roller 41 is adjustable in order to control the pressure from the second belt 40 and where the position of the second roller 42 is fixed. The first infeed belt is in one example longer than the second infeed belt.

The position of the second roller of the first infeed belt is adjusted with a first linear actuator 43 that is arranged to set the distance between the front part of the first belt and the second belt. This distance will in turn set the pressure acting on the return pulp sheet which will secure that the return pulp sheet is fed to the mill head in a consistent manner. The position of the first roller 41 of the second infeed belt 40 is adjusted with a second linear actuator 44 that is arranged to set the distance between the rear part of the first belt and the second belt. This distance will in turn set the pressure acting on the return pulp sheet which will secure that the return pulp sheet is fed to the mill head in a consistent manner. The distance at the front part and the rear part between the first infeed belt and the second infeed belt is preferably correlated such that the return pulp sheet is fed to the mill head without slippage. The distance can be adapted to the type of return pulp sheet.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Moreover, features of the example embodiments described herein may be combined with features of other example embodiments described herein. Furthermore, modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims. Reference signs mentioned in the claims should not be seen as limiting the extent of the matter protected by the claims, and their sole function is to make claims easier to understand.

REFERENCE SIGNS

| | |
|---|---|
| 1: | Product forming unit |
| 2: | Cellulose blank structure |
| 3: | Forming mould |
| 4: | Blank dry-forming module |
| 5: | Buffering module |
| 6: | Pressing module |
| 7: | Blank recycling module |
| 8: | Barrier application module |
| 9: | Cellulose raw material |
| 10: | Mill |
| 11: | Mill head |
| 12: | Enclosure |
| 13: | Inlet opening |
| 14: | Outlet opening |
| 15: | Infeed region |
| 16: | First infeed path |
| 17: | Second infeed path |
| 18: | First pulp sheet |
| 19: | Second pulp sheet |
| 20: | Braker bar |
| 21: | Upper part |
| 22: | Lower part |
| 23: | Braker bar inlet |
| 24: | Feeder roller |
| 25: | First passive roller |
| 26: | Second passive roller |
| 27: | First actuator |
| 28: | Second actuator |
| 29: | First detector |
| 30: | Second detector |
| 31: | First holding means |
| 32: | Second holding means |
| 33: | First stop member |
| 34: | Second holder means |
| 35: | Return infeed path |
| 36: | Return braker bar |
| 37: | First infeed belt |
| 38: | First roller |
| 39: | Second roller |
| 40: | Second infeed belt |
| 41: | First roller |
| 42: | Second roller |
| 43: | First linear actuator |
| 44: | Second linear actuator |
| 45: | Return pulp sheet |
| 46: | Electronic control unit (ECU) |

1. A mill for separating fibres from a compressed pulp sheet for forming non-flat cellulose products from an air-formed cellulose blank structure, the mill comprising:
a mill head for separating fibres from a compressed pulp sheet;
an enclosure enclosing the mill head;
an inlet opening for air;
an outlet opening for an air-fibre mixture;
an infeed region arranged to feed a first pulp sheet or a second pulp sheet to the mill head,
wherein the infeed region comprises a first infeed path and a second infeed path, where the first infeed path is in an active state when the second infeed path is in an idle state, where a first pulp sheet is arranged to be fed to the mill head by the active first infeed path, and where the second pulp sheet is arranged to rest in the idle second infeed path,
wherein the infeed region is arranged to switch state of the infeed paths when a signal is issued indicating the end of a first pulp sheet in the active first infeed path, and
wherein the infeed region comprises a driven feeder roller, where the feeder roller is arranged to rotate in a first direction when feeding a first pulp sheet to the mill head in the first infeed path, and to rotate in a second direction when feeding a second pulp sheet to the mill head in the second infeed path.

2. The mill according to claim 1, wherein the infeed region comprises a first displaceable passive roller arranged in the first infeed path and a second displaceable passive roller arranged in the second infeed path, where the first displaceable passive roller is arranged to bear on the first pulp sheet when the first infeed path is in an active state such that the first pulp sheet is securely held between the driven feeder roller and the first passive roller, and where the second displaceable passive roller is arranged to be retracted when the second infeed path is in an idle state.

3. The mill according to claim 1, wherein the first infeed path comprises first holding means arranged to hold a first pulp sheet in a fixed position when the first infeed path is in an idle state, and wherein the second infeed path comprises second holding means arranged to hold a second pulp sheet in a fixed position when the second infeed path is in an idle state.

4. The mill according to claim 1, wherein the first infeed path comprises a first detector arranged to detect the end of the first pulp sheet in the first infeed path, and that the second infeed path comprises a second detector arranged to detect the end of a second pulp sheet in the second infeed path.

5. The mill according to claim 4, wherein the mill comprises an electronic control unit arranged to control the rotational direction of the feeder roller, the position of the first passive roller and the position of the second passive roller, in dependency of a signal issued by the first detector and/or the second detector.

6. The mill according to claim 1, wherein the infeed region comprises a braker bar having an upper part and a lower part arranged to hold and guide a pulp sheet when the pulp sheet is fed to the mill head, where the braker bar is provided with radiuses at the edges of the braker bar inlet.

7. The mill according to claim 1, wherein the mill further comprises a return infeed path arranged to receive return pulp sheet from a pressing module, where the return infeed path comprises a first infeed belt and a second infeed belt.

8. The mill according to claim 7, wherein the first infeed belt is provided with a first roller and a second roller, where the position of the first roller is fixed and the position of the second roller is adjustable in order to control the pressure from the first infeed belt, and where the second infeed belt is provided with a first roller and a second roller, where the position of the first roller is adjustable in order to control the pressure from the second infeed belt and where the position of the second roller is fixed.

9. The mill according to claim 7, wherein the first infeed belt is longer than the second infeed belt.

10. The mill according to claim 7, wherein the adjustment of the second roller of the first infeed belt is performed by a first linear actuator and the adjustment of the first roller of the second infeed belt is performed by a second linear actuator.

11. The mill according to claim 7, wherein the return infeed path comprises a return braker bar arranged to hold and guide the return pulp sheet when the return pulp sheet is fed to the mill head, where the return braker bar is provided with radiuses at the edges of the return braker bar inlet.

12. A method for separating fibres from a compressed pulp sheet by using a mill, the method comprising the steps of:
feeding a first pulp sheet to a mill head of the mill in a first infeed path by rotating a feeder roller in a first direction, where the first infeed path is in an active state;
positioning a second pulp sheet in a second infeed path, where the second infeed path is in an idle state, where the second pulp sheet is held in a fixed position;
monitoring the first pulp sheet in the first infeed path with a first detector arranged in the first infeed path;
when the first detector indicates the end of the first pulp sheet in the first infeed path, rotating the feeder roller in a second direction such that the first pulp sheet of the first infeed path is removed from the mill head, and feeding the second pulp sheet of the second infeed path to the mill head by rotating the feeder roller in the second direction.

13. A method according to claim 12, wherein the second pulp sheet is held in the fixed position by second holding means.

14. The method according to claim 12, wherein the first pulp sheet is pressed towards the feeder roller by a first passive roller when the first infeed path is in the active state, and where the second pulp sheet is pressed towards the feeder roller by a second passive roller when the second infeed path is in the active state.
